(19) United States
(12) Patent Application Publication
(10) Pub. No.: US 2011/0093325 A1
(43) Pub. Date: Apr. 21, 2011

(54) Automated Financial Institution Customer Reward Program

(75) Inventors: Richard B. Kelsky, Stillwater, NJ (US); Anthony A. Napolitano, Rockaway, NJ (US)

(73) Assignee: TELLERMETRIX, INC., Rockaway, NJ (US)

(21) Appl. No.: 12/603,269

(22) Filed: Oct. 21, 2009

(51) Int. Cl. G06Q 30/00; G06Q 40/00

(52) U.S. Cl. 705/14.33; 705/14.27

(57) ABSTRACT

A method and system for automating a reward program for a financial institution is provided. Accordingly, information about a customer transaction is received by a system and an affinity-point value of the transaction item is determined and associated with the transaction item. An affinity-point balance associated with the customer is determined and one or more rewards that are available to the customer are determined. A notification concerning a particular reward for which the customer is eligible is displayed. Multiple reward programs can be operated simultaneously and customers can participate in multiple reward programs. Thus, after determining an affinity-point balance, a list of rewards available to the customer can be determined from multiple reward programs and the list of rewards can be sorted based on associated affinity-point value and based on a prioritization of the various reward programs.

### FIELD OF THE INVENTION

The present invention relates generally to the automation of a consumer reward program, and more particularly to the automation and administration of a reward program associated with a financial institution.

### BACKGROUND

Most businesses rely on repeat customers to increase revenues and profits. To that end, many marketing efforts are directed toward existing customers. One such effort includes rewarding customers for repeat or increased business. Preferably, these marketing efforts can be extended or modified to also attract new customers. However, some industries and business sectors have not developed automated techniques for encouraging and/or rewarding repeat business.

### SUMMARY OF THE INVENTION

A method and system for automating a reward program for a financial institution is provided. More specifically, in accordance with an embodiment of the present invention, information about a customer transaction is received by a system of the financial institution. An affinity-point value of the transaction is determined and associated with the transaction. Based on the determined affinity-point value, an affinity-point balance associated with the customer is determined. One or more rewards that are available to the customer are determined and a notification concerning a particular reward for which the customer is eligible is displayed.

The financial institution can operate and track multiple reward programs. Similarly, a customer can participate in multiple reward programs. Accordingly, after determining an affinity-point balance, a list of rewards available to the customer can be determined from multiple reward programs. The list of rewards can be sorted based on associated affinity-point value and further sorted based on a prioritization of the various reward programs.

Reward programs can be iterative or cumulative. In accordance with an iterative reward program, rewards can be automatically distributed to a customer in a periodic manner. A cumulative program allows the customer to accumulate affinity-points which can be used to obtain various awards at a time of the customer's choosing.

Affinity points can be awarded based on nearly any set of events and conditions. For example, transactions with the financial institution or a third party can be the basis for affinity-point accumulation. Various system events, customer associated events, and other user determined-events can be associated with affinity-points. Additionally, conditions, such as previously awarded affinity-points and/or transaction meta-data criteria, can be used to determine whether to award affinity-points and/or the number of affinity-points awarded.

In yet a further embodiment of the present invention, a system for establishing a financial institution reward program is provided. The system includes an event definition module configured to associate events with affinity based on at least one filter and a program definition module configured to associate affinity-points with a customer based on an occurrence of an event and the associations of the event definition module. A reward module is configured to associated rewards with affinity-points, and a redemption module is configured to distribute rewards based on affinity-points and reward-redemption criteria.

In accordance with further aspects of the present invention, events can include check cashing, payday lending, banking, money service business transactions, and/or point-of-sale transactions at a third party. Filters can be based on meta-data concerning a customer transaction.

These and other advantages of the invention will be apparent to those of ordinary skill in the art by reference to the following detailed description and the accompanying drawings.

### BRIEF DESCRIPTION OF THE DRAWINGS

FIG. 1 is an illustration of an network environment in accordance with an embodiment of the present invention;

FIG. 2 is a flow diagram of a process in accordance with an embodiment of the present invention;

FIG. 3 is a diagram of a system in accordance with an embodiment of the present invention; and

FIG. 4 is a high-level block diagram of a computer in accordance with an embodiment.

### DETAILED DESCRIPTION

By way of overview and introduction, the present invention provides a system and method for establishing and automating a financial institution reward program. The reward program can be designed to encourage existing customers to engage in additional or more frequent transactions with the financial institution or a third party with which the financial institution has partnered. For example, a financial institution such as a payday lender, check-cashing store, or bank can establish a program that awards points for each transaction by a customer at the store. Once the customer has earned a sufficient number of points, the customer can trade in the points for a particular reward item, such as a television or a toaster. Alternatively, a customer may be awarded a free money order for every four money orders that are purchased.

The reward program can track and provide rewards on a variety of bases. Therefore, we herein refer to the accumulation of points and other earned data as affinity-points so as to more accurately describe the present invention. Furthermore, it should be noted that affinity-points can be earned for a variety of events, such as a customer anniversary or each visit to an affiliated store regardless of purchases, and are not restricted to money spent or the number of transactions at a store. Additionally, a variety of conditions can be established that determine the quantity of affinity-points awarded for a specific event. For example, it may be possible to limit the award of affinity-points to particular days of the week, for transactions over a certain amount, or to ensure a customer is awarded affinity-points for a store visit only once a day.

As customers earn affinity-points, rewards can be automatically distributed (e.g., buy four get one free) or selected for redemption (e.g., 1000 affinity-points for a television). A financial institution can operate multiple reward programs simultaneously. A customer can participate in the multiple programs as well. When a customer engages in a transaction at the financial institution, a transaction terminal can automatically display a notification to the customer or the teller regarding one or more of the rewards for which the customer is eligible. For example, the terminal can notify the teller and the customer that the customer has purchased 4 money orders and the fifth money order of this transaction is free. Alternatively, the terminal can notify the customer that if the customer earns 100 more affinity-points, the customer can receive a free television.

The foregoing provides a brief overview of some of the features of the present invention. These and other features are described in further detail below with reference to the figures.

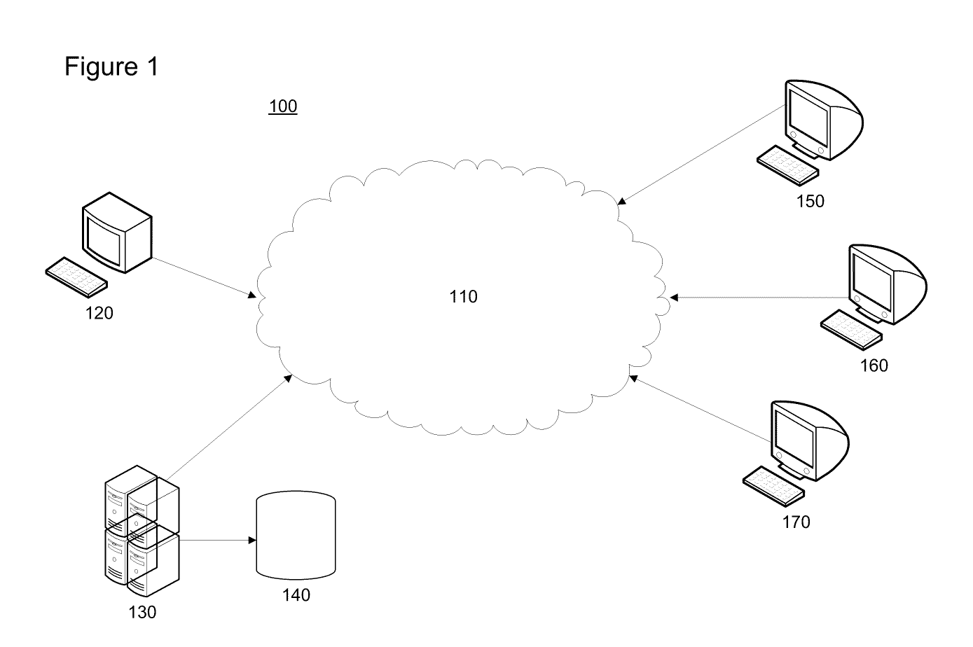

FIG. 1 illustrates a network environment 100 which can be utilized in accordance with an embodiment of the present invention. The network environment 100 includes a network 110 for communication between a server 130 executing the financial institution reward program and other computers, such as terminal 120 at a storefront of a financial institution and/or terminals 150, 160, and 170 at various third-party businesses. While illustrated as a single terminal 120, a person of ordinary skill in the art would understand that multiple instances of terminals 120 can be located at multiple financial institution storefronts and connected to network 110 to communicate with server 130. Server 130 includes a database 140 that is used to store and access the data generated by and input into the reward program.

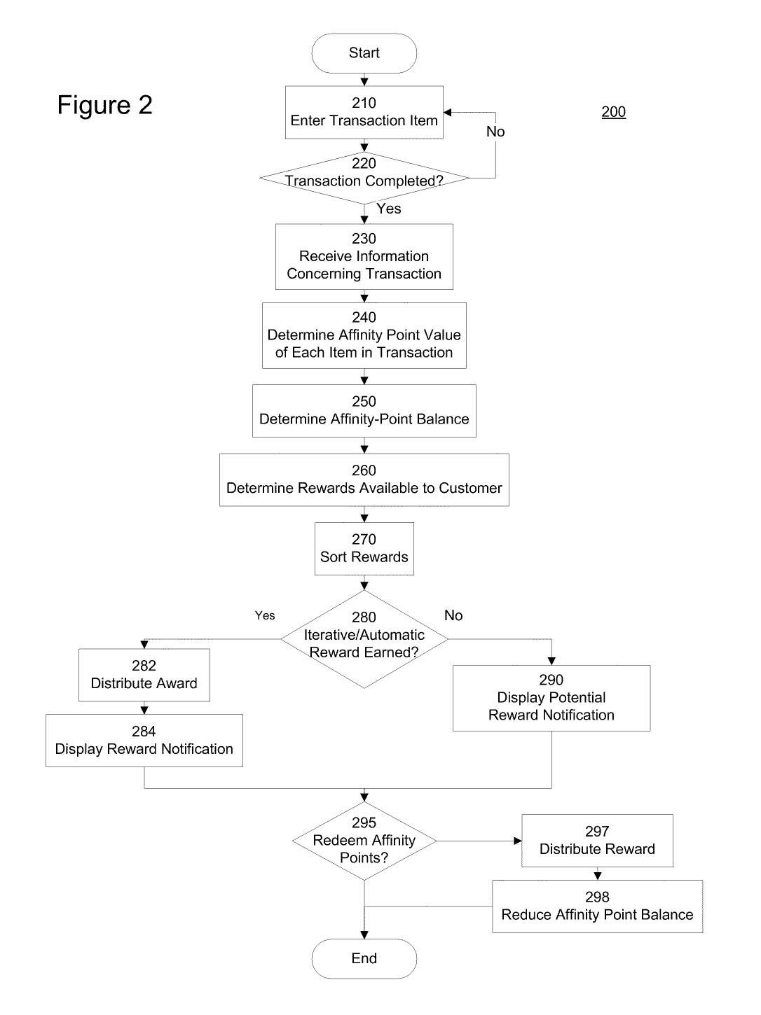

FIG. 2 is a flow diagram of a process 200 in accordance with an embodiment of the present invention. Process 200 is discussed below with reference to the network environment 100 illustrated in FIG. 1. The process 200 illustrates an exemplary flow of a customer interaction with a financial institution reward program. A financial institution, in accordance with an embodiment of the present invention, can include a payday lender, check cashing service, a bank, or other money business service (MSB). In accordance with the present invention, a customer transaction is anything that is tracked by the reward program. For example, a customer transaction can include the number, type, and dollar amount of purchases at the financial institution or participating third party store. A customer transaction can further include a customer's birthday, wedding anniversary, customer anniversary, or other memorialized date. Furthermore, each customer visit to a store, the temperature or weather on a particular day, and nearly any other event that is input into the system can be associated with a customer and treated as a customer transaction.

At step 210 of process 200, a transaction item is entered. The transaction can be entered via terminal 120, for example at a payday lender storefront, or at a third-party storefront terminal 150. As discussed above, the transaction item can include non-financial transactions such as weather, anniversaries, and store visits, and it can include financial transactions (e.g., purchases, cashed checks, loans, etc.) at the financial institution or a participating third-party entity. At step 220, the system determines whether the transaction is completed (i.e., whether all transaction items have been entered). This determination can be made at the server 130 or at the terminal processing the transaction. If additional transaction items exist, the process 200 can return to step 210 to enter additional transactions. Alternatively, if no further transaction items need to be entered, the system can complete the transaction.

At step 230, information concerning the transaction is received by the server 130 operating the reward program and stored in the database 140. If the transaction is at a terminal 120 of a store associated with the financial institution, the receipt of information at step 230 can include transmitting data to one of several central servers 130. Alternatively, the terminal 120 and the server 130 can be operating on the same platform such that receiving information concerning the transaction at step 230 can simply include transmitting the data to another software module within the terminal 120. Alternatively, information concerning transactions at third-party entities 150, 160, or 170 can be transmitted to or input into the financial institution reward program. For example, data concerning a transaction at a restaurant can be automatically transmitted to the financial institution reward program server 130 via a terminal 150 at the restaurant. Alternatively, an employee of the restaurant can enter the transaction information manually into a webpage of a financial institution reward program or other data entry technique.

Each transaction item is associated with an affinity-point value at step 240. These associations are stored in the database 140, which is accessible by server 130. Certain transaction items may not qualify for affinity-points and are therefore automatically associated with zero affinity-points or excluded from affinity-point determination. Other transaction items are automatically awarded affinity-points. Alternatively, various filters can be applied to each transaction item to determine the amount of affinity to associate with the transaction item. A filter is one or more criteria with which the transaction item is evaluated to determine whether to award affinity-points and the quantity of affinity-points to award. Filter criteria can be based on any information about the transaction (i.e., transaction data or meta-data), the customer (i.e., customer data or meta-data), or any other information input into the system. Furthermore, a filter can comprise a Boolean equation of multiple criteria. For example, the transaction item may be awarded more or less affinity-points based on the dollar value of the transaction. In a further example, a check-cashing transaction may earn affinity-points only if it is for more than $100 and it occurs on Monday. In yet a further example, a visit to the store may earn 10 affinity-points, but only if the customer has not already visited the store that day. Multiple criteria can be combined to generate a filter, and multiple filters can be combined to determine the affinity-points associated with a transaction item.

An affinity-point balance is then determined for the customer at step 250. The affinity-point balance can be determined by summing affinity-points from previous transactions and transaction items that are stored in the database 140. A customer's previous affinity point balance or previous transactions are stored in the database 140 and can be evaluated to determine a current affinity-point balance. Affinity-points can be set to expire after a period of time. Therefore, during this determination, affinity-points can be reviewed to determine if any are stale and should be removed from the customer's account and not included in the affinity-point balance. An affinity-point balance can be on a per-customer basis (i.e., the sum of affinity-points earned by a customer across programs) or on a per-reward program basis (i.e., the sum of affinity-points earned by a customer within a single reward program).

At step 260, the system determines a list of rewards available to a customer. This determination can be made by querying the database 140 for all programs for which the customer is registered and all rewards offered through each reward program. The list is then sorted at step 270. The list of rewards can be sorted by an affinity-point value associated with each reward. This sorting can be performed across multiple reward programs in which the customer is participating or within each specific reward program. The list can further be sorted based on a prioritization of the reward programs.

Based on the affinity-point balance of the customer, the system can determine whether an iterative and/or automatic reward has been earned. Iterative rewards are distributed on a periodic basis and can include promotions such as receiving every fourth money order free. An automatic reward is distributed automatically once a filter or a certain criterion is satisfied. Automatic rewards can include a change in the customer's status. For example, if the customer earns sufficient affinity-points, a customer can be automatically upgraded to higher status (e.g., gold or platinum status), which provides the customer with various benefits including the possibility of earning affinity-points at a faster rate (e.g., more affinity-points for the same transaction as compared to a lower customer status) or other intangible benefits (e.g., a checkout line a storefront dedicated to servicing platinum members). If an iterative or automatic award has been earned, the award is distributed at step 282 and a notification concerning the reward is displayed at step 284.

At step 290, if no iterative or automatic award is earned, a notification can be displayed concerning a reward for which the customer is eligible. An eligible reward is one for which the customer is qualified (e.g., the customer participating in the reward program has not earned the reward previously, and no other conditions exist that would bar the customer from receiving the reward) but may or may not have earned (i.e., the customer may or may not have sufficient affinity-points to receive the reward). The eligible reward can be the top reward of the sorted list of available rewards or selected based on other configurable criteria. The notification at step 290 can inform either the customer or the teller that the customer can receive the specific reward in exchange for an associated number of affinity-points or that the reward can be earned if the customer earns and additional quantity of affinity-points. The notification can be made on a display to the teller or a display to the customer at terminal 120. Alternatively, the notification can be printed on a receipt or other paper that is handed to the customer. In yet a further alternative, the notification can be sent to the customer by mail, electronic mail, instant message, short message service (SMS), or other electronic message.

If the customer is eligible for a reward, the customer can choose at step 295 to redeem affinity points for the award. At step 297, the reward is distributed to the customer, and at step 298, the customer's affinity point balance is reduced by the amount associated with the distributed award. Award distribution can include physically handing and item to the customer, placing an order for an item that is then delivered to the store or to a customer-specified address, or by making a notation in the system (e.g., customer used 1000 affinity-points to upgrade to platinum status).

In accordance with further features of the present invention, coupons can be used with or generated by the system. For example, the financial institution can generate coupons which are distributed virtually (e.g., online or via other computerized methods) or physically. Each coupon includes an identification code, such as a globally unique identifier (GUID) or an obfuscated GUID for security. The coupon can be designed for use at either the financial institution or a third party entity.

In accordance with one embodiment, the identification code on the coupon can be treated as information concerning a transaction at step 230. That is, for example, if a coupon is used at either the financial institution or a third-party entity, when that information is received by the financial institution reward program, the use of the coupon code can result in the customer earning affinity-points. Furthermore, the affinity-point value of a transaction item can be determined by the identification code of the coupon. In accordance with a further embodiment, the coupon can be distributed as a reward under one of the financial institution reward programs. Alternatively, a coupon can be used as both a reward and information concerning a transaction that results in earned affinity-points.

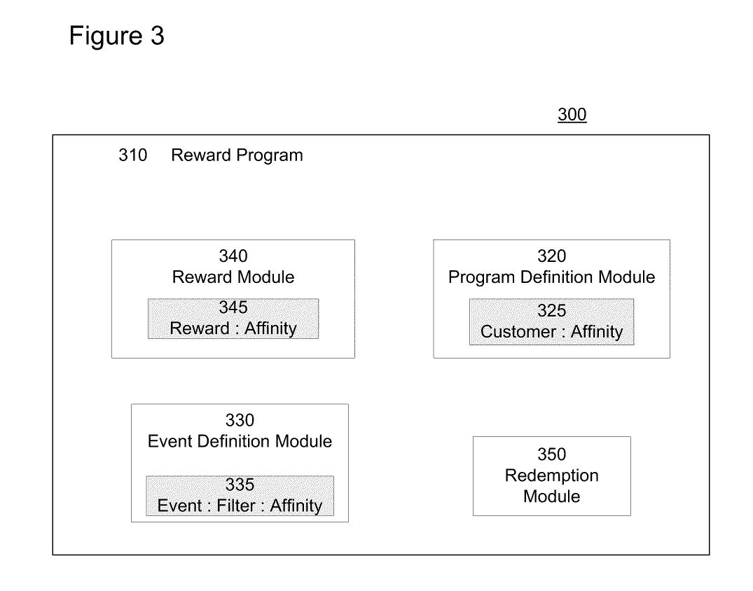

FIG. 3 is a diagram of a system 300 for implementing a financial institution reward program in accordance with the present invention. Specifically, system 300 can implement the financial institution reward program as a reward program 310 having an event definition module 330 configured to associate events with affinity based on at least one filter as described above. The event, affinity, filter association can be stored as table 335 in the database 140. While illustrated as a single table 335, a person of ordinary skill in the art would understand that filters can be stored in a separate table that is queried along with a table storing events and affinity association. An event within system 300 can include any information that is tracked by the system. For example, events include point-of-sale transactions at the financial institution (e.g., check cashing, payday lending, and money service business transactions) or at a third-party entity. Events can further include the occurrence of an anniversary (e.g., customer birthday, customer anniversary, anniversary of customer signing up for the financial institution reward program, a store anniversary, etc.), an initial customer setup, a holiday, a defined weather condition, a designated date range, and/or a milestone transaction (e.g., a particular cardinality of customer transactions, a sum total dollar amount of transactions, a total volume of transactions at a store, etc.). A designated date range can be defined by the institution establishing the program and may be used to encourage customers to conduct business on a specific day of the week (e.g., Monday or Friday) or specific days (e.g., the last day of the month, or the last three days of the month). Each of these events alone or in combination can be associated with an affinity value based on the application of a variety of filters and conditions to the events.

The system 300 further includes a program definition module 320 configured to associate and award affinity-points to a customer based on occurrence of an event and the associations of the event definition module. The customer and affinity association can be stored as table 325 in the database 140. The program definition module can include additional details regarding the financial institution reward program, including whether the program is iterative or cumulative, the period during which a customer can earn affinity under the program, and the time period during which a customer can redeem affinity under the program.

A reward module 340 of system 300 is configured to associated rewards with affinity-points, and a redemption module 350 is configured distribute rewards based on affinity-points and reward-redemption criteria. The reward and affinity association of the reward module 340 can be stored as table 345 in the database 140.

Multiple reward programs 310 can be active within a financial institution reward program system. Additionally, a single event can register with multiple financial institution reward programs, such that a single transaction item of a customer can earn affinity under multiple programs. Thus, each financial institution reward program can be configured to track affinity individually.

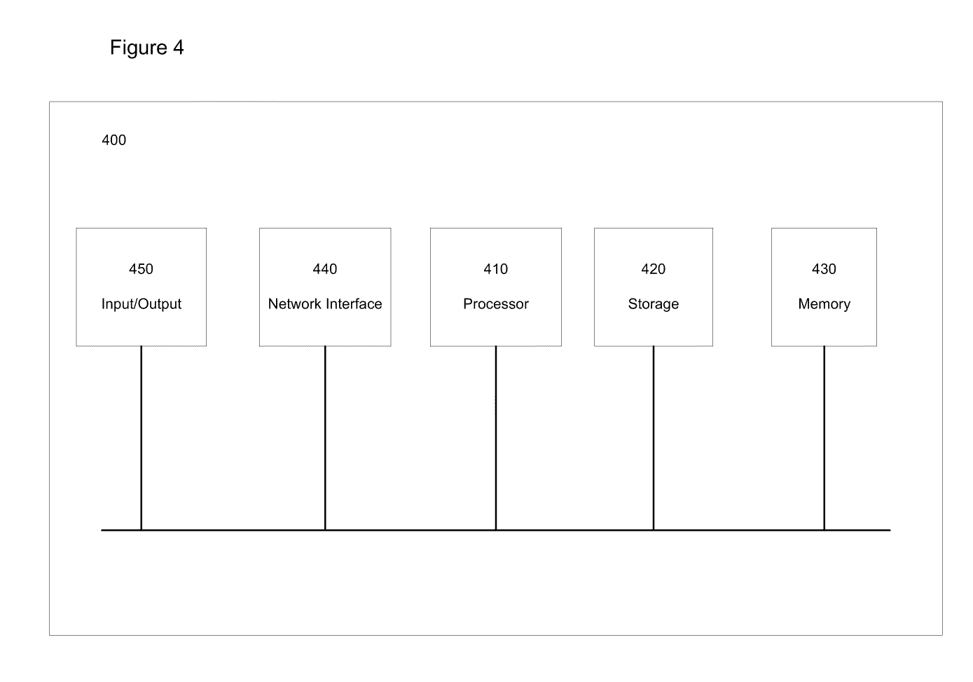

The above-described methods and systems for establishing and automating a financial institution reward program can be implemented on a computer using well-known computer processors, memory units, storage devices, computer software, and other components. A high-level block diagram of such a computer is illustrated in FIG. 4. Computer 400 contains a processor 410 which controls the overall operation of the computer 400 by executing computer program instructions which define such operations. The computer program instructions may be stored in a storage device 420, or other computer readable medium (e.g., magnetic disk, CD ROM, etc.), and loaded into memory 430 when execution of the computer program instructions is desired. Thus, the method steps of FIG. 3 can be defined by the computer program instructions stored in the memory 430 and/or storage 420 and controlled by the processor 410 executing the computer program instructions.

For example, the computer program instructions can be implemented as computer executable code programmed by one skilled in the art to perform an algorithm defined by the method steps of FIG. 2 and a system defined by the modules of FIG. 3. Accordingly, by executing the computer program instructions, the processor 410 executes an algorithm defined by the method steps of FIG. 3. The computer 400 also includes one or more network interfaces 440 for communicating with other devices via a network. The computer 400 also includes input/output devices 450 that enable user interaction with the computer 400 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

We claim:

1. A computer implemented method of automating a financial institution reward program comprising:
receiving information regarding a transaction for a customer;
determining an affinity-point value of the transaction based on the received information;
determining an affinity-point balance associated with the customer based at least on the affinity-point value of the financial transaction;
determining at least one reward available to the customer; and
displaying a notification concerning a particular reward of the at least one reward for which the customer is eligible based on the affinity-point balance.

2. The method of claim 1, wherein a plurality of rewards are determined to be available to the customer, further comprising sorting the plurality of rewards based at least on affinity-point value associated with each of the rewards, wherein the notification concerning a particular reward concerns a first reward of the sorted plurality of rewards.

3. The method of claim 2, wherein the plurality of rewards is sorted further based on an assigned prioritization of the plurality of reward programs.

4. The method of claim 2, wherein the plurality of rewards comprises rewards selected from a plurality of reward programs.

5. The method of claim 4, wherein at least one of the plurality of reward programs is an iterative reward program.

6. The method of claim 4, wherein at least one of the plurality of reward programs is a cumulative reward program.

7. The method of claim 2, wherein the plurality of rewards is further sorted based on an assigned prioritization of the plurality of rewards.

8. The method of claim 1, further comprising:
distributing the at least one reward to the customer; and
reducing the affinity-point balance by an affinity-point value associated with the at least one reward,
wherein the notification concerns the distribution of the at least one reward.

9. The method of claim 1, further comprising:
determining an iterative reward criteria has been satisfied; and
automatically distributing at least one iterative reward in response to the determination that the iterative reward criteria has been satisfied.

10. The method of claim 1, wherein determining the affinity-point value of the transaction is further based on customer associated information.

11. The method of claim 1, wherein the information received regarding the transaction concerns a transaction between the customer and a third party.

12. The method of claim 1, wherein the information received includes an identifier on a coupon issued as part of the financial institution reward program at one or more of the financial institution and a third party.

13. The method of claim 12, wherein determining the affinity-point value of the transaction is further based on the identifier.

14. The method of claim 1, wherein the at least one reward includes a customer status.

15. The method of claim 1, wherein the affinity-point balance is further based at least on a previous affinity-point balance.

16. A system for automating a financial institution reward program comprising:
means for receiving information regarding a transaction for a customer;
means for determining an affinity-point value of the transaction based on the received information;
means for determining an affinity-point balance associated with the customer based at least on the affinity-point value of the financial transaction;
means for determining at least one reward available to the customer; and
means for displaying a notification concerning a particular reward of the at least one reward for which the customer is eligible based on the affinity-point balance.

17. The system of claim 16, wherein a plurality of rewards are determined to be available to the customer, further comprising means for sorting the plurality of rewards based at least on affinity-point value associated with each of the rewards, wherein the notification concerning a particular reward concerns a first reward of the sorted plurality of rewards.

18. The system of claim 17, further comprising means for sorting the plurality of rewards based on an assigned prioritization of the plurality of reward programs.

19. The system of claim 17, wherein the plurality of rewards comprises rewards selected from a plurality of reward programs.

20. The system of claim 19, wherein at least one of the plurality of reward programs is an iterative reward program.

21. The system of claim 21, wherein at least one of the plurality of reward programs is a cumulative reward program.

22. The system of claim 18, further comprising means for sorting the plurality of rewards based on an assigned prioritization of the plurality of rewards.

23. The system of claim 17, further comprising:
means for distributing the at least one reward to the customer; and
means for reducing the affinity-point balance by an affinity-point value associated with the at least one reward,
wherein the notification concerns the distribution of the at least one reward.

24. The system of claim 17, further comprising:
means for determining an iterative reward criteria has been satisfied; and
means for automatically distributing at least one iterative reward in response to the determination that the iterative reward criteria has been satisfied.

25. The system of claim 17, wherein the means for determining the affinity-point value of the transaction is further based on customer associated information.

26. The system of claim 17, wherein the information received regarding the transaction concerns a transaction between the customer and a third party.

27. The system of claim 17, wherein the information received includes an identifier on a coupon issued as part of the financial institution reward program for use at one or more of the financial institution and a third party entity.

28. The system of claim 27, wherein the means for determining the affinity-point value of the transaction is further based on the identifier.

29. The system of claim 16, wherein the at least one reward includes a customer status.

30. The system of claim 16, wherein the affinity-point balance is further based at least on a previous affinity-point balance.

31. A system for establishing a financial institution reward program comprising:
an event definition module configured to associate events with affinity based on at least one filter;
a program definition module configured to associate affinity-points with a customer based on occurrence of an event and the associations of the event definition module;
a reward module configured to associated rewards with affinity-points; and
a redemption module configured distribute rewards based on affinity-points and reward-redemption criteria.

32. The system of claim 31, wherein the events include at least one of check cashing, payday lending, banking transactions, and money service business transactions.

33. The system of claim 31, wherein the events include point-of-sale transactions at a third party.

34. The system of claim 31, wherein the at least one filter is based on meta-data concerning a customer transaction.

35. The system of claim 31, wherein each event is one of a system event and a data event, the system event comprising at least one of an anniversary, an initial customer setup, a holiday, a designated date range, and a milestone transaction, the data event comprising customer meta-data associated with an affinity-point value.
